(19) United States
(12) Patent Application Publication
(10) Pub. No.: US 2014/0006922 A1
(43) Pub. Date: Jan. 2, 2014

(54) COMPARISON OUTPUT OF ELECTRONIC DOCUMENTS

(71) Applicants: Alex Smith, Surry, ME (US); Shawn A Gaither, Raleigh, NC (US)

(72) Inventors: Alex Smith, Surry, ME (US); Shawn A Gaither, Raleigh, NC (US)

(21) Appl. No.: 12/101,922

(22) Filed: Apr. 11, 2008

(51) Int. Cl. G06F 17/00

(52) U.S. Cl. 715/234

(57) ABSTRACT

In some example, a computerized method includes receiving a first electronic document and a second electronic document. The computerized method includes performing a comparison operation between the first electronic document and the second electronic document. The computerized method also includes mapping a first markup of the first electronic document that includes at least one annotation that identifies changes to the first electronic document relative to the second electronic document based on the comparison operation. The computerized method includes mapping a second markup of the second electronic document that includes at least one annotation that identifies changes to the second electronic document relative to the first electronic document based on the comparison operation, wherein the changes identified in the first markup are symmetrical relative to the changes identified in the second markup. The computerized method includes storing, into a machine-readable medium, the first markup of the first electronic document and the second markup of the second electronic document.

### COPYRIGHT

A portion of the disclosure of this document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever. The following notice applies to the software, data, and/or screenshots which may be described below and in the drawings that form a part of this document: Copyright© 2008, Adobe Systems Incorporated. All Rights Reserved.

### BACKGROUND

The approaches described in this section could be pursued, but are not necessarily approaches that have been previously conceived or pursued. Therefore, unless otherwise indicated herein, the approaches described in this section are not prior art to the claims in this application and are not admitted to be prior art by inclusion in this section.

Across different versions of an electronic document, content may be inserted, deleted, moved, etc. Comparison of different versions of an electronic document enables such changes to be determined.

### BRIEF DESCRIPTION OF THE DRAWINGS

The embodiments are provided by way of example and not limitation in the figures of the accompanying drawings, in which like references indicate similar elements and in which:

FIG. 1 is a system diagram for outputting multiple, symmetrical markups of comparison of electronic documents, according to some example embodiments.

FIGS. 2 and 3 show a first example electronic document and a second example electronic document, respectively, for determining differences between, according to some example embodiments.

FIG. 4 is a diagram of a method for outputting multiple markups of comparison of electronic documents, according to some example embodiments.

FIG. 5 is a markup of the first electronic document relative to the second electronic document, according to some example embodiments.

FIG. 6 is a markup of the second electronic document relative to the first electronic document, according to some example embodiments.

FIG. 7 illustrates a screen shot of an output for a markup, according to some example embodiments.

FIG. 8 illustrates a computer that may be used for comparison output of electronic documents, according to some example embodiments.

### DETAILED DESCRIPTION

Methods, apparatus and systems for comparison output of electronic documents are described. In the following description, numerous specific details are set forth. However, it is understood that embodiments of the invention may be practiced without these specific details. In other instances, structures and techniques have not been shown in detail in order not to obscure the understanding of this description.

As used herein, the term “electronic document” may comprise any type of electronic content for use in electronic form. Examples of an electronic document may comprise Portable Document Format (“PDF”) which may be viewed and modified in one of the ADOBE® ACROBAT® programs, a web page, a word processing document (such as a Microsoft® Word document), a spread sheet document, page-descriptive electronic content, hypertext document, a markup language document, declarative specification document (such as for example a hypertext markup language HTML or XML document), a fillable form or data describing application graphical user interface, etc.

Example embodiments outputs differences between at least two documents. Assume that two documents (document A and document B) are compared to each other. In some example embodiments, the output comprises markups to document A relative to document B as well as markups to document B relative to document B. Accordingly, some example embodiments apply markups to both documents that are being compared (based on a single comparison there between). The markups may comprise any number of annotations that shows the changes between the two electronic documents. For example, the annotations may include additions, deletions, movements, etc. of data for one electronic document in comparison to a different electronic document. In some example embodiments, the changes in one markup are symmetrical to the changes in a second markup. Accordingly, for an annotation of a change for a first markup, there is a corresponding annotation of a change for the second markup. For example, if one markup includes an annotation of an addition of data, the second markup would include a corresponding annotation of the deletion of data. Thus, the markup entries in the two documents are complementary. In particular, the markup entry for the first document is a logical inversion of the markup entry for the second document. (e.g., deletion in the first document is an insertion in the second document).

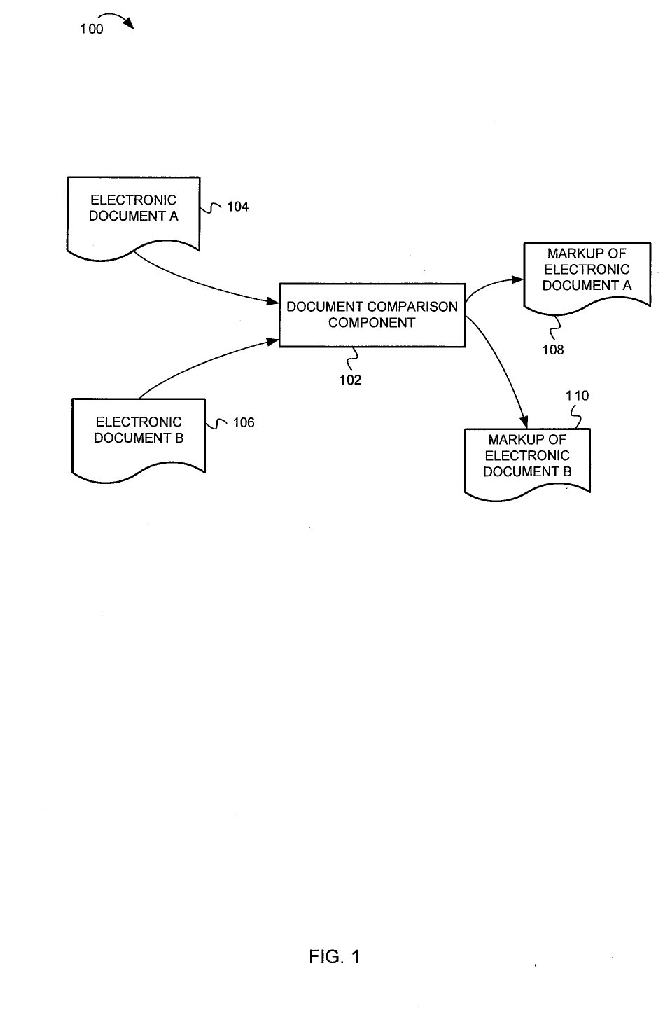

FIG. 1 is a system diagram for outputting multiple, symmetrical markups of comparison of electronic documents, according to some example embodiments. A system 100 comprises a document comparison component 102. The system 100 also comprises electronic documents to be input into the document comparison component 102. Document A 104 and document B 106 are input into the document comparison component 102. As further described below, the document comparison component 102 processes the document A 102 and the document B 106 to determine the differences between the electronic documents. The document comparison component 102 outputs multiple markups that show the differences between electronic documents. In some example embodiments, the multiple markups are symmetrical relative to each other (as further described below). As shown, the document comparison component 102 outputs a markup of the electronic document A 108 and a markup of the electronic document B 110.

In some example embodiments, the document comparison component 102, the documents, and the markups may be stored on a same or different machine-readable medium. Alternatively, all or some may be stored in different machine-readable media. For example, the electronic document A 104 and the electronic document B 106 may be stored in different machine-readable media on remote servers that are accessed by the document comparison component 102. The document comparison component 102 may then output the markup 108 and the markup 110 for storage on a local or remote machine-readable media. The document comparison component 102 may be software, hardware, firmware or a combination thereof for executing operations, according to some example embodiments.

The machine-readable media that store the data and components described above includes any mechanism which provides (e.g., stores and/or transmits) information in a form accessible by a machine (e.g., a computer, a network device, a personal digital assistant, manufacturing tool, any device with a set of one or more processors, etc.). In some example embodiments, the machine-readable media includes volatile and/or non-volatile media (e.g., read only memory (ROM), random access memory (RAM), magnetic disk storage media, optical storage media, flash memory devices, etc.).

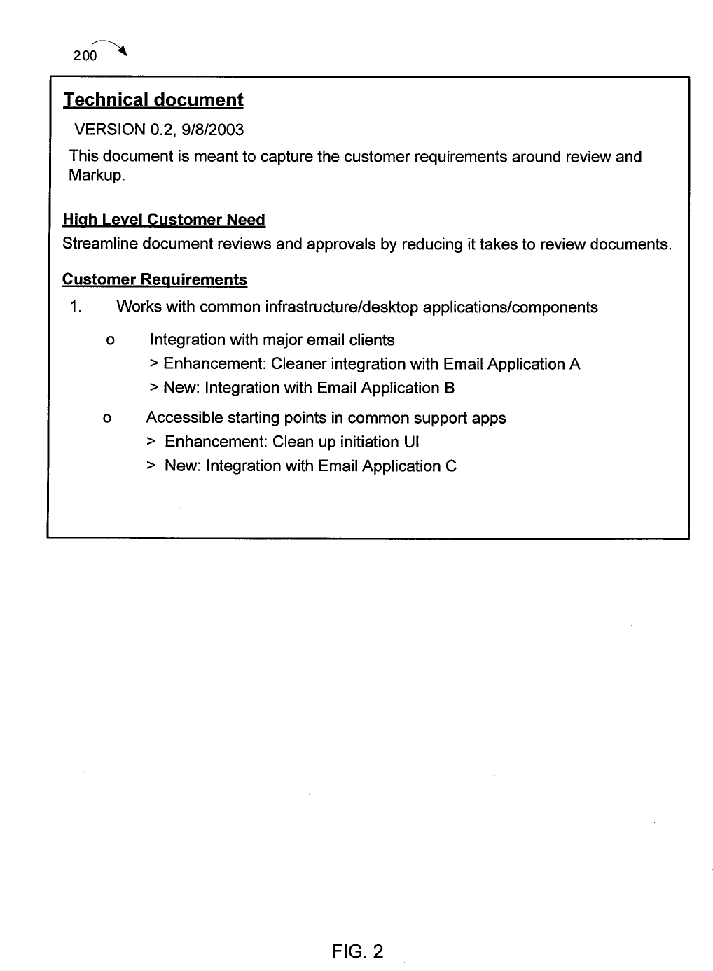

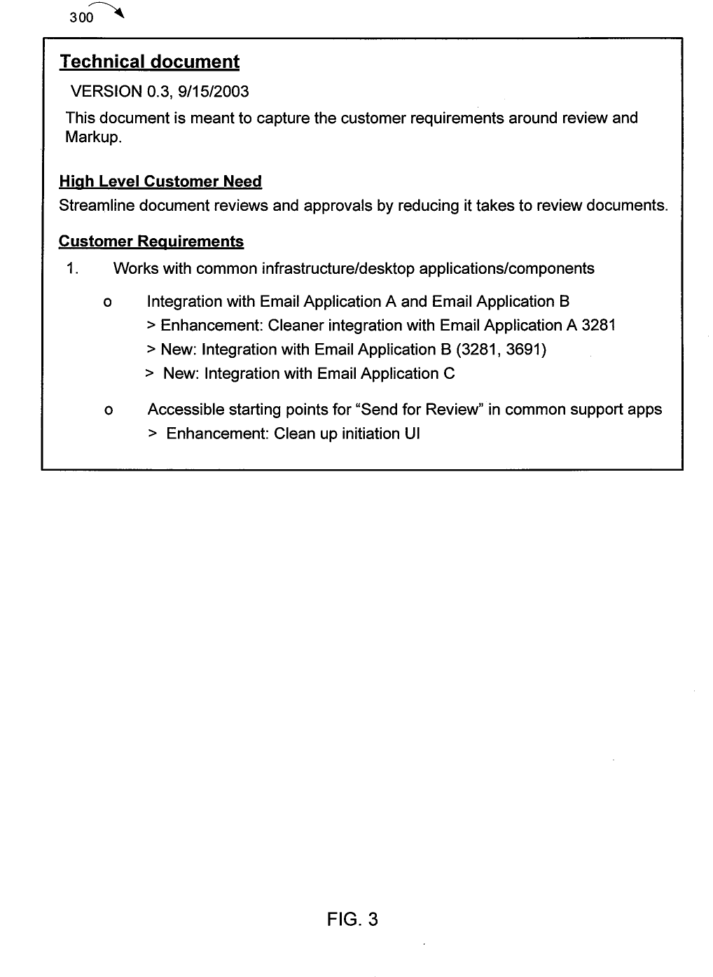

FIGS. 2 and 3 show a first example electronic document and a second example electronic document, respectively, for determining differences between, according to some example embodiments. In particular, FIGS. 2 and 3 illustrate different versions of a document that are to be compared by the document comparison component 102, according to some example embodiments. FIGS. 2 and 3 include a first electronic document 200 and a second electronic document 300, respectively. As further described below, the second electronic document 300 is a later version of the first electronic document 200. The second electronic document 300 includes deletions, additions and movement of data.

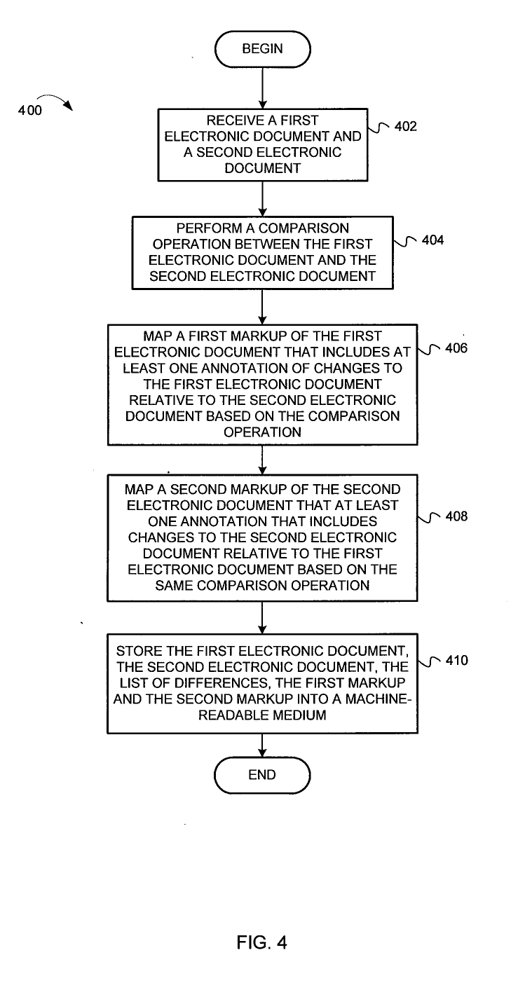

Operations, according to example embodiments, are now described. In certain embodiments, the operations are performed by instructions residing on machine-readable media (e.g., software), while in other embodiments, the methods are performed by hardware or other logic (e.g., digital logic). FIG. 4 is a diagram of a method for outputting multiple markups of comparison of electronic documents, according to some example embodiments. A method 400 is described with reference to FIG. 1. In some example embodiments, the method 400 is performed by the document comparison component 102. While described with reference to two electronic documents, in some example embodiments, such operations may be performed on any number of such electronic documents. The method 400 commences at block 402.

At block 402, the document comparison component 102 receives the electronic document A 104 and the electronic document B 106. As described above, these documents may be received from local and/or remote machine-readable media. The method continues at block 404.

At block 404, the document comparison component 102 performs a comparison operations between the first electronic document A 104 and the second electronic document B 106. The document comparison component 102 may use any number of different types of comparison operations to determine the differences between electronic documents. In some example embodiments, the document comparison component 102 uses at least one of the comparison operations described in U.S. Pending patent application Ser. No. 12/033,505, titled “Determination of Differences between Electronic Documents”, inventor—Shawn A. Gaither, filed on Feb. 19, 2008, which is hereby incorporated by reference. The comparison operation outputs differences between the electronic documents, including additions, deletions, replacements, movement of data, etc. The method continues at block 406.

At block 406, the document comparison component 102 maps a first markup of the first electronic document that includes at least one annotation that identifies changes to the first electronic document relative to the second electronic document based on the comparison operation. The markup may include annotations of what changes (including additions, deletions, replacement, movement, etc.) to the data have occurred between the first electronic document and the second electronic document. In some example embodiments, this markup is from the perspective of the first electronic document. As further described below, in some example embodiments, the annotations in the multiple markups generated from this comparison operation are symmetrical relative to each other. In some example embodiments, symmetrical for two electronic documents is defined such that there is a one-to-one relationship between the annotations in the first electronic document and the annotations in the second electronic document. Accordingly, for an annotation of a change for a first markup, there is a corresponding annotation of a change for the second markup. For example, if one markup includes an annotation of an addition of data, the second markup would include a corresponding annotation of the deletion of data. Thus, the markup entries in the two documents are complementary. In particular, the markup entry for the first document is a logical inversion of the markup entry for the second document. (e.g., deletion in the first document is an insertion in the second document). Accordingly, some example embodiments enable the generation of multiple markups having symmetrical annotations from a single comparison operation. This enables reviewers of such markups to more easily and quickly review these multiple markups from different perspectives.

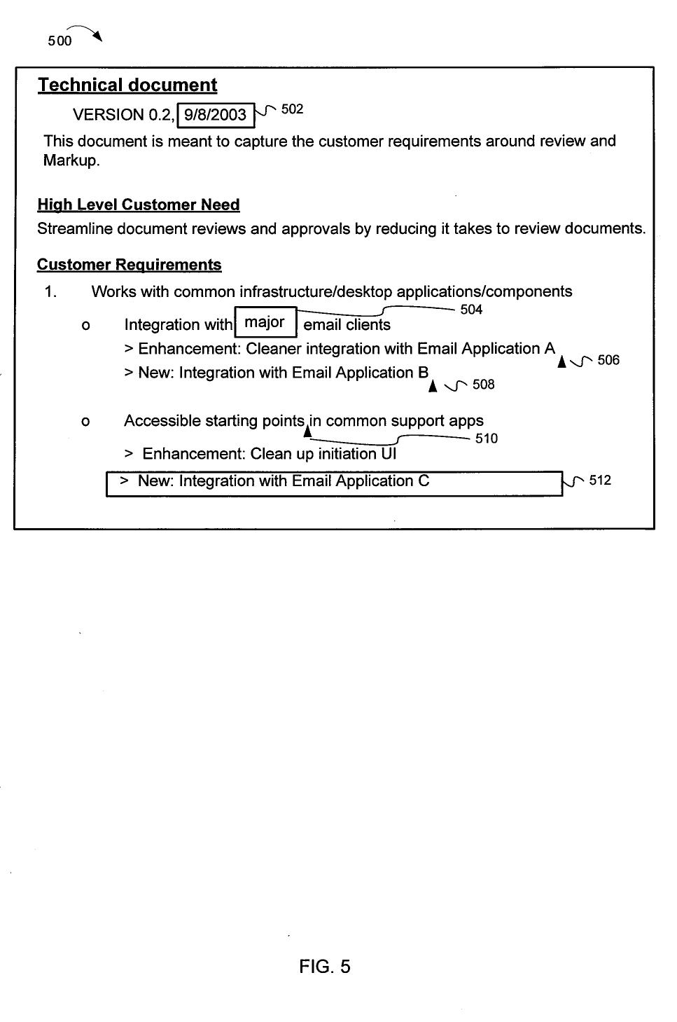

To illustrate, FIG. 5 illustrates a markup of the first electronic document relative to the second electronic document, according to some example embodiments. FIG. 5 illustrates a first markup 500. Based on the comparison operation, six different annotations that identifies that changes are marked for the first electronic document. An annotation 502 is a replacement of the date for the version. The date of 9/8/2003 replaces the date of 9/15/2003 in the second electronic document. Accordingly, the annotation 502 is denoted by a box surrounding the data that is replaced. An annotation 504 is also a replacement of data. In particular, the term “major” replaces a specific list of email applications. The annotation 504 is also denoted by a box surrounding the data that is replaced.

An annotation 506 is a deletion of data. In particular, data from the second electronic document is not included in the first electronic document. Thus, the arrow for the change 506 denotes that the data “(3281)” from the second electronic document is not included in the first electronic document. An annotation 508 is also a deletion of data. The arrow for the annotation 508 denotes that the data “(3281, 3691)” from the second electronic document is not included in the first electronic document. An annotation 510 is also a deletion of data. The arrow for the annotation 510 denotes that the data “for ‘Send for Review’” from the second electronic document is not included in the first electronic document. An annotation 512 is a movement of data. In particular, data remains the same but changes locations within the two electronic documents. Returning to FIG. 4, the method 400 continues at block 408.

At block 408, the document comparison component 102 maps a second markup of the second electronic document that includes at least one annotation that identifies changes to the second electronic document relative to the first electronic document based on the comparison operation. The markup may include annotations of what changes (including additions, deletions, replacement, movement, etc.) to the data have occurred between the first electronic document and the second electronic document. In some example embodiments, this markup is from the perspective of the second electronic document.

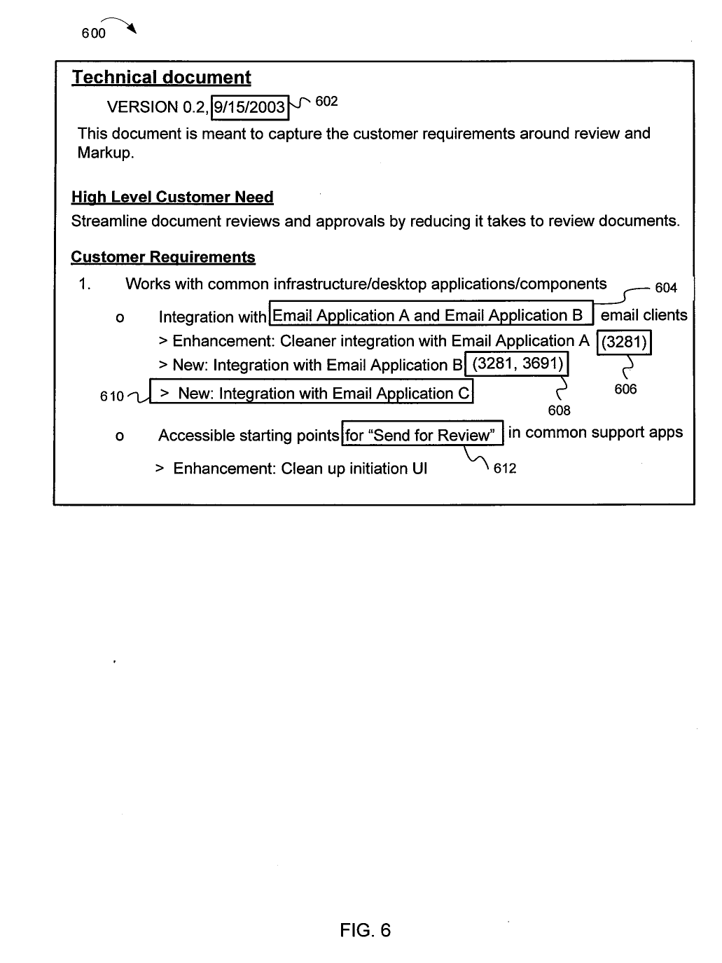

To illustrate, FIG. 6 is a markup of the second electronic document relative to the first electronic document, according to some example embodiments. FIG. 6 includes a second markup 600. Based on the comparison operation, six different annotations that identifies that changes are marked for the second electronic document. As now described, in some embodiments, the annotations in the first markup (shown in FIG. 5) are symmetrical to the annotations in the second markup (shown in FIG. 6). An annotation 602 is a replacement of the date for the version. The date of 9/15/2003 is replaced in the first electronic document by a different date. Accordingly, the annotation 602 is denoted by a box surrounding the data that is replaced. The annotation 602 is symmetrical to the annotation 502. In particular, the annotation 602 matches the annotation 502, wherein the change in data between the two electronic documents is illustrated.

An annotation 604 is also a replacement of data. In particular, the phrase “Email Application A and Email Application B” in the second electronic document replaces the term “major” in the first electronic document. The annotation 604 is also denoted by a box surrounding the data that is replaced. The annotation is symmetrical to the annotation 504. In particular, the annotation 604 matches the annotation 402, wherein the change in data between the two electronic documents is illustrated.

An annotation 606 is an addition of data. In particular, data has been added to the second electronic document that was not included in the first electronic document. The term “(3281)” has been added in the second electronic document. The annotation 606 is denoted as a box that includes the data. The annotation 606 matches the annotation 506 (shown as an arrow in FIG. 5).

An annotation 608 is also an addition of data. In particular, data has been added to the second electronic document that was not included in the first electronic document. The term “(3281, 3691)” has been added in the second electronic document. The annotation 608 is denoted as a box that includes the data. The annotation 608 matches the annotation 508 (shown as an arrow in FIG. 5).

An annotation 610 is a movement of data. In particular, data remains the same but changes locations within the two electronic documents. The annotation 610 is denoted as a box that includes the data. The annotation 610 matches the annotation 512 in FIG. 5. An annotation 612 is an addition of data. In particular, data has been added to the second electronic document that was not included in the first electronic document. The phrase “for ‘Send for Review’” has been added in the second electronic document. The annotation 612 is denoted as a box that includes the data. The annotation 612 matches the annotation 510 (shown as an arrow in FIG. 5). Accordingly, as described, in some example embodiments, the annotations in the multiple markups are symmetrical. In particular, in some example embodiments, there is a matching of annotations across the multiple markups. Returning to FIG. 4, the method 400 continues at block 410.

At block 410, the document comparison component 102 stores the first electronic document, the second electronic document, difference data (e.g., a list of differences), the first markup and the second markup into a machine-readable medium. In some example embodiments, the document comparison component 102 may store such data on the same or different machine-readable media and the same or different data file. In some example embodiments, the document comparison component 102 may embed or attach one electronic document into or onto the other electronic document. In some example embodiments, the document comparison component 102 may store the first electronic document, the second electronic document, the list of differences, the first markup and the second markup into a same data file to enable easier storage, transmission, etc. of such data. The method 400 is complete.

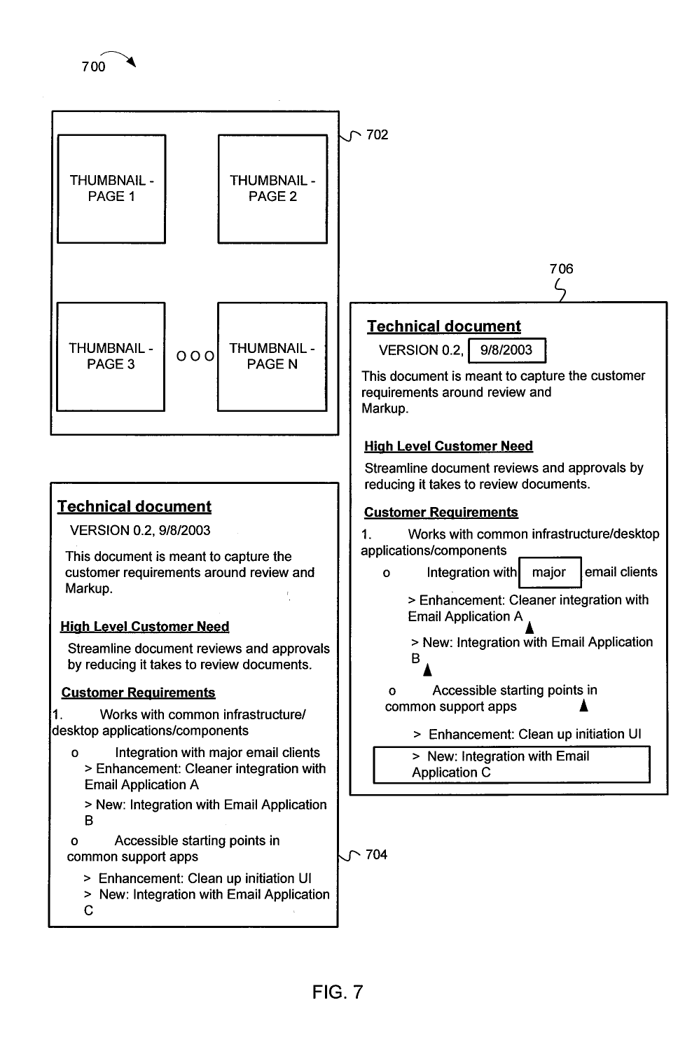

FIG. 7 illustrates a screen shot of an output for a markup, according to some example embodiments. In particular, FIG. 7 illustrates a screen shot 700 for the first electronic document (see FIG. 2). The screen shot 700 comprises thumbnails 702, an original page 704 and a markup 706 from the perspective of the first electronic document. A user may select any of the thumbnails. After a thumbnail is selected, the page represented by the thumbnail is displayed as the original page 704. In some example embodiments, if the original page 704 is selected, the operations of the method 400 are executed and the markup 706 is generated and displayed (as shown).

In some example embodiments, the user interface enables to easily switch the perspective of the comparison. In particular, the user interface enables an easy switch between showing markups from the perspective of the old document and showing markups from the perspective of the new document. In some example embodiments, a user may select a page preview button that causes a second window to be opened that is similar to the screen shot 700. This second window displays from the perspective of the second electronic document. Accordingly, thumbnails and the original page are for the second electronic document. Moreover, the markup is from the perspective of the second electronic document. Thus, the user can flip between documents or tile the windows for a side-by-side view. Accordingly, the user can see the results of the comparison operation played back from the perspective of both documents.

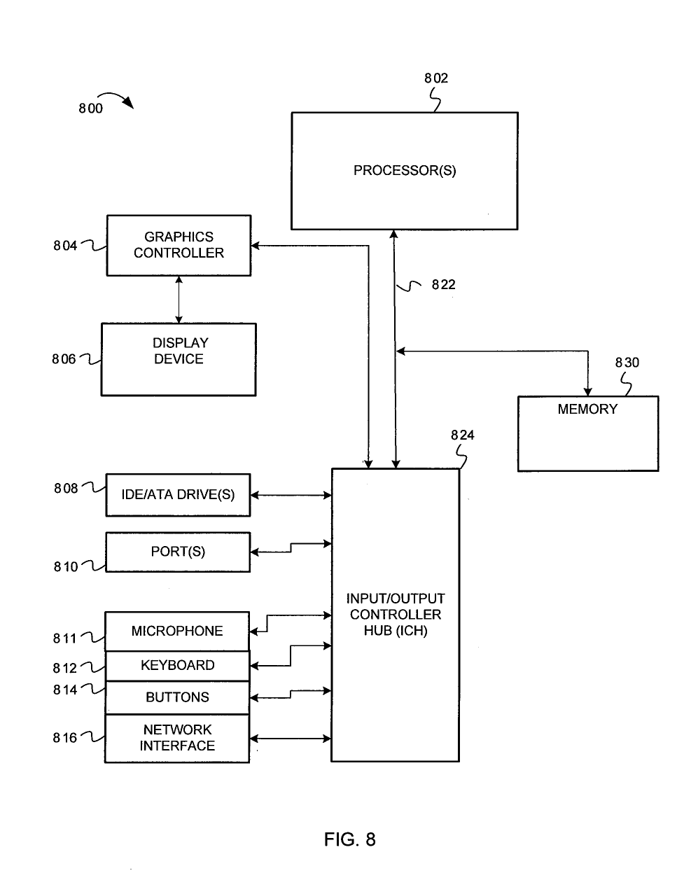

A detailed block diagram of an example computer environment, according to some embodiments, is now described. In particular, FIG. 8 illustrates a computer that may be used for comparison output of electronic documents, according to some example embodiments. A computer system 800 may be representative of a client device, the server, etc.

As illustrated in FIG. 8, the computer system 800 comprises processor(s) 802. The computer system 800 also includes a memory unit 830, processor bus 822, and Input/Output controller hub (ICH) 824. The processor(s) 802, memory unit 830, and ICH 824 are coupled to the processor bus 822. The processor(s) 802 may comprise any suitable processor architecture. The computer system 800 may comprise one, two, three, or more processors, any of which may execute a set of instructions in accordance with embodiments of the invention.

The memory unit 830 may store data and/or instructions, and may comprise any suitable memory, such as a dynamic random access memory (DRAM). The computer system 800 also includes IDE drive(s) 808 and/or other suitable storage devices. A graphics controller 804 controls the display of information on a display device 806, according to some embodiments of the invention.

The input/output controller hub (ICH) 824 provides an interface to I/O devices or peripheral components for the computer system 800. The ICH 824 may comprise any suitable interface controller to provide for any suitable communication link to the processor(s) 802, memory unit 830 and/or to any suitable device or component in communication with the ICH 824. For one embodiment of the invention, the ICH 824 provides suitable arbitration and buffering for each interface.

For some embodiments of the invention, the ICH 824 provides an interface to one or more suitable integrated drive electronics (IDE) drives 808, such as a hard disk drive (HDD) or compact disc read only memory (CD ROM) drive, or to suitable universal serial bus (USB) devices through one or more USB ports 810. For one embodiment, the ICH 824 also provides an interface to a keyboard 812, a mouse 814, a CD-ROM drive 818, one or more suitable devices through one or more Firewire ports 816. For one embodiment of the invention, the ICH 824 also provides a network interface 820 though which the computer system 800 can communicate with other computers and/or devices.

In some embodiments, the computer system 800 includes a machine-readable medium that stores a set of instructions (e.g., software) embodying any one, or all, of the methodologies for described herein. Furthermore, software may reside, completely or at least partially, within memory unit 830 and/or within the processor(s) 802.

In the description, numerous specific details such as logic implementations, opcodes, means to specify operands, resource partitioning/sharing/duplication implementations, types and interrelationships of system components, and logic partitioning/integration choices are set forth in order to provide a more thorough understanding of the present invention. It will be appreciated, however, by one skilled in the art that embodiments of the invention may be practiced without such specific details. In other instances, control structures, gate level circuits and full software instruction sequences have not been shown in detail in order not to obscure the embodiments of the invention. Those of ordinary skill in the art, with the included descriptions will be able to implement appropriate functionality without undue experimentation.

References in the specification to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Embodiments of the invention include features, methods or processes that may be embodied within machine-executable instructions provided by a machine-readable medium. A machine-readable medium includes any mechanism which provides (i.e., stores and/or transmits) information in a form accessible by a machine (e.g., a computer, a network device, a personal digital assistant, manufacturing tool, any device with a set of one or more processors, etc.). In example embodiments, a machine-readable medium includes volatile and/or non-volatile media (e.g., read only memory (ROM), random access memory (RAM), magnetic disk storage media, optical storage media, flash memory devices, etc.).

Such instructions are utilized to cause a general or special purpose processor, programmed with the instructions, to perform methods or processes of the embodiments of the invention. Alternatively, the features or operations of embodiments of the invention are performed by specific hardware components which contain hard-wired logic for performing the operations, or by any combination of programmed data processing components and specific hardware components. Embodiments of the invention include software, data processing hardware, data processing system-implemented methods, and various processing operations, further described herein.

In view of the wide variety of permutations to the embodiments described herein, this detailed description is intended to be illustrative only, and should not be taken as limiting the scope of the invention. What is claimed as the invention, therefore, is all such modifications as may come within the scope and spirit of the following claims and equivalents thereto. Therefore, the specification and drawings are to be regarded in an illustrative rather than a restrictive sense.

1. A computerized method comprising:
presenting a user interface including a plurality of thumbnails that represent pages of a first electronic document;
receiving a first selection of a thumbnail of a page from the plurality of thumbnails;
receiving a second selection of the page that is displayed based on the first selection of the thumbnail, the second selection triggering a single comparison of the page;
in response to the second selection of the page represented by the selected thumbnail, accessing the first electronic document and a second electronic document and performing the single comparison between the first electronic document and the second electronic document;
generating a first markup document of the first electronic document that includes at least one annotation that identifies changes to the first electronic document relative to the second electronic document based on the single comparison; and
generating a second markup document of the second electronic document that includes at least one annotation that identifies changes to the second electronic document relative to the first electronic document based on the single comparison, the changes identified in the first markup document being a logical inversion relative to the changes identified in the second markup document.

2. The computerized method of claim 1, wherein an insertion into the second electronic document is mapped into the second markup document as an output of inserted data, wherein the insertion into the second electronic document is mapped into the first markup document as an output of an indicator of the insertion that does not include the inserted data.

3. The computerized method of claim 1, wherein the first markup document and the second markup document comprises at least one of an insertion of data, a deletion of data, a replacement of data, or a movement of data.

4. The computerized method of claim 1, further comprising outputting the first markup document of the first electronic document and the second markup document of the second electronic document on a same display.

5. The computerized method of claim 1, further comprising embedding the second electronic document into the first electronic document.

6. The computerized method of claim 1, wherein:
the performing of the comparison comprises outputting a list of differences between the first electronic document and the second electronic document that is used to map markups to the first electronic document and the second electronic document,
the generating the first markup document of the first electronic document based on the single comparison comprises mapping at least one difference from the generated list, and
the generating the second markup document of the second electronic document based on the single comparison comprises mapping the at least one difference from the generated list.

7. The computerized method of claim 6, wherein the first markup document, the second markup document, the first electronic document, the second electronic document, and the list of differences are stored on a single data file in the machine-readable medium.

8. A non-transitory machine-readable medium including instructions, which when executed by a machine cause the machine to perform operations comprising:
presenting a user interface including a plurality of thumbnails that represent pages of a first electronic document;
receiving a first selection of a thumbnail of a page from the plurality of thumbnails;
receiving a second selection of the page that is displayed based on the first selection of the thumbnail, the second selection triggering a single comparison of the page;
in response the second selection of the page represented by the selected thumbnail, performing the single comparison between the first electronic document and a second electronic document; and
performing a mapping, based on the single comparison, to generate more than one markup document, a first markup document of the more than one markup document including at least one annotation that includes changes to the first electronic document relative to the second electronic document and wherein a second markup document of the more than one markup document includes at least one annotation of changes to the second electronic document relative to the first electronic document, the changes identified in the first markup document and the changes identified in the second markup document being a logical inversion relative to each other.

9. The non-transitory machine-readable medium of claim 8, wherein an insertion into the second electronic document is mapped into the second markup document as an output of inserted data, wherein the insertion into the second electronic document is mapped into the first markup document as an output of an indicator of the insertion that does not include the inserted data.

10. The non-transitory machine-readable medium of claim 8, wherein the first markup document and the second markup document comprises at least one of an insertion of data, a deletion of data, a replacement of data, or a movement of data.

11. The non-transitory machine-readable medium of claim 8, further comprising embedding the second electronic document into the first electronic document.

12. The non-transitory machine-readable medium of claim 8, wherein:
the performing of the single comparison comprises outputting a list of differences between the first electronic document and the second electronic document that is used to map markups to the first electronic document and the second electronic document,
the generating the first markup document of the first electronic document based on the single comparison comprises mapping at least one difference from the generated list, and
the generating the second markup document of the second electronic document based on the single comparison comprises mapping the at least one difference from the generated list.

13. The non-transitory machine-readable medium of claim 12, wherein the first markup document, the second markup document, the first electronic document, the second electronic document, and the list of differences are stored on a single data file in the machine-readable medium.

14. A non-transitory machine-readable medium comprising:
a first electronic document that includes an embedded second electronic document;
a list of difference data identifying at least one difference between the first electronic document and the embedded second electronic document that is derived from a single comparison between the first electronic document and the embedded second electronic document created in response to a first selection of a thumbnail of a page from the plurality of thumbnails and a second selection of the page that is displayed based on the first selection of the thumbnail, the second selection triggering the single comparison of the page represented by a selected thumbnail from a user interface that included a plurality of thumbnails representing pages of the first electronic document;
a first markup document of a first electronic document, which is derived from the single comparison between the first electronic document and the embedded second electronic document, the first markup document comprising an annotation that identifies a change to the first electronic document as compared to a second electronic document; and
a second markup document of the second electronic document, which is derived from the single comparison between the first electronic document and the embedded second electronic document, the second markup document comprising a different annotation that identifies a change to the embedded second electronic document as compared to first electronic document, the annotation and the different annotation being a logical inversion of each other.

15. The non-transitory machine-readable medium of claim 14, wherein an insertion into the second electronic document is mapped into the second markup document as an output of inserted data, and wherein the insertion into the second electronic document is mapped into the first markup document as an output of an indicator of the insertion that does not include the inserted data.

16. The non-transitory machine-readable medium of claim 14, wherein the first markup document and the second markup document comprises at least one of an insertion of data, a deletion of data, a replacement of data, or a movement of data.

17. The non-transitory machine-readable medium of claim 14, wherein the first electronic document, the list of difference data, the first markup document, and the second markup document are stored in a same data file.

18. An apparatus comprising:
a non-transitory machine-readable medium to store a first electronic document and a second electronic document; and
a document comparison component to generate, in response to an first selection of a thumbnail of a page from the plurality of thumbnails and a second selection of the page that is displayed based on the first selection of the thumbnail, the second selection triggering a single comparison of the page represented by the selected thumbnail from a user interface that included a plurality of thumbnails representing pages of the first electronic document, more than one markup document of differences between the first electronic document and the second electronic document, a first markup document of the more than one markup document including changes to the first electronic document relative to the second electronic document, and a second markup document of the more than one markup document including changes to the second electronic document relative to the first electronic document, the changes included in the first markup document and the changes included in the second markup document being a logical inversion relative to each other.

19. The apparatus of claim 18, wherein an insertion into the second electronic document is mapped into the second markup document as an output of inserted data, wherein the insertion into the second electronic document is mapped into the first markup document as an output of an indicator of the insertion that does not includes the inserted data.

20. The apparatus of claim 18, wherein the first markup document and the second markup document comprises at least one of an insertion of data, a deletion of data, a replacement of data, or a movement of data.

21. The apparatus of claim 18, wherein the document comparison component is to embed the second electronic document into the first electronic document.

22. The apparatus of claim 18, wherein the document comparison component is to store the first electronic document, a list of the differences between the first electronic document and the second electronic document, and the more than one markup document in a single data file.

23. The computerized method of claim 1, further comprising updating the user interface to present the page represented by the selected thumbnail and a markup page of the first markup document that corresponds to the page represented by the selected thumbnail.
